(19) United States
(12) Patent Application Publication
(10) Pub. No.: US 2009/0168442 A1
(43) Pub. Date: Jul. 2, 2009

(54) HUBCAP FIXING STRUCTURE

(76) Inventor: Ta CHEN, Tainan (TW)

Correspondence Address: Ta CHEN, P. O. BOX 90, Tainan City 70499, TW

(21) Appl. No.: 11/967,274

(22) Filed: Dec. 31, 2007

(51) Int. Cl. B60Q 1/00

(52) U.S. Cl. 362/500

(57) ABSTRACT

A hubcap fixing structure includes a main body having its front side provided with a recessed surface that has a through hole in its center, a plurality of studs at its rear side, a decorative plate positioned thereon and a transparent cover covered thereon. A counter weight block is assembled in the main body. A luminous unit positioned in the main body consists of a micro-generator, a connecting plate and a circuit board that is provided with at least one LED. The connecting plate and the circuit board are connected together and secured with the main body. A base connected with the luminous unit has a central hole for receiving the micro-generator and a plurality of engage blocks protruded at its underside with their inner walls engaged with a spring ring. So this structure is quick and stable in assembly, preventing patterns on the decorative plate from fading and exfoliating.

### BACKGROUND OF THE INVENTION

1. Field of the Invention

This invention relates to a hubcap fixing structure, particularly to one able to be quickly and stably assembled at an outer side of a wheel axle and preset with original patterns preventable from fading and exfoliating, thus increasing decorations for the lateral side of an automobile and having warning effect for enhancing driving safety.

2. Description of the Prior Art

Previously, a wheel rim cover is used for covering an outer side of an automobile wheel rim, but nowadays the structure and shape of some wheel rims are specially designed for matching with integration of the external form of an automobile, and hence wheel rim covers are not necessarily applicable to automobiles with newly designed styles. However, the outer side of a wheel axle that is an essential structure still can be assembled thereon with a hubcap for covering the mechanical structure as well as for decoration. Generally, a conventional hubcap is firmly secured at an outer side of a wheel axle by bolts and provided with no figures or patterns, or only painted thereon with colored drawings, lacking of originality or visual esthetic sense. In addition, the colored drawings painted on the surface of the hubcap are likely to fade or exfoliate because of being exposed to inclemency of the elements and scratching.

### SUMMARY OF THE INVENTION

The objective of this invention is to offer a hubcap fixing structure able to be quickly and stably assembled at an outer side of a wheel axle and provided with a decorative plate preset thereon with original colored patterns preventable from fading or exfoliating, thus increasing decoration for the lateral side of an automobile and having warning effect for enhancing driving safety.

The main characteristic of the invention includes a main body, a counter weight block, a luminous unit and a base. The main body is formed with a hollow interior and provided with a recessed surface at its front side. The recessed surface bored with a through hole in its center and fixed with a plurality of studs at its rear side. A decorative plate is disposed on the recessed surface and a transparent cover is covered on the recessed surface. The counter weight block is threadably assembled in the main body and bored with at least one insert hole. The luminous unit positioned in the main body is composed of a micro-generator, a connecting plate and a circuit board. The connecting plate and the circuit board are connected together and secured with the main body, and the circuit board is provided with at least one LED. The base connected with the luminous unit is provided with a central hole for receiving the micro-generator of the luminous unit and a plurality of engage blocks protruded at its underside. The engage blocks have their inner walls engaged with a spring ring.

### BRIEF DESCRIPTION OF DRAWINGS

This invention will be better understood by referring to the accompanying drawings, wherein:

FIG. 1 is an exploded perspective view of a hubcap fixing structure in the present invention;

FIG. 2 is a perspective view of the hubcap fixing structure in the present invention; and

FIG. 3 is a side cross-sectional view of the hubcap fixing structure in the present invention.

### DETAILED DESCRIPTION OF THE PREFERRED EMBODIMENT

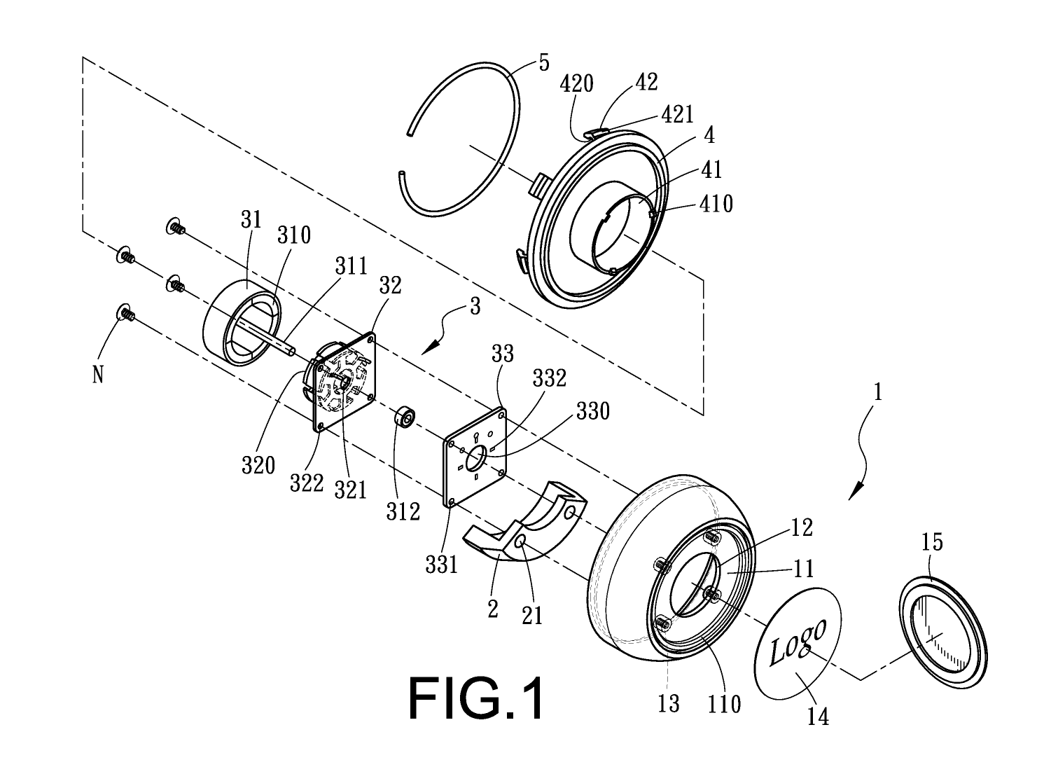

A preferred embodiment of a hubcap fixing structure in the present invention, as shown in FIG. 1, includes a main body 1, a counter weight block 2, a luminous unit 3 and a base 4 as main components combined together.

The main body 1 being an interior hollow body is provided with a recessed surface 11 at its front side. The recessed surface 11 has a holding stepped edge 110 disposed in the circumference, a through hole 12 bored in the center and a plurality of studs 13 fixed at the rear side. A decorative plate 14 is positioned on the recessed surface 11 to be preset with patterns or logos. A transparent cover 15 is covered on the recessed surface 11.

The counter weight block 2 is threadably assembled in the main body 1 and bored with two insert holes 21 to be correspondingly secured with the plurality of studs 13 of the main body 1 by means of bolts (N).

The luminous unit 3 positioned in the main body 1 is composed of a micro-generator 31, a connecting plate 32 and a circuit board 33. The micro-generator 31 has a magnet 310 around the inner wall and a shaft 311 extending outward in the center. The connecting plate 32 positioned in front of the micro-generator 31 has a coil 320 disposed at the rear side thereof to be received in the interior of the micro-generator 31 with its outer edge closely resting against the inner diameter of the magnet 310, a through hole 321 bored in the center for the shaft 311 of the micro-generator 31 to protrude out therethrough with a fixing member 312 fitted at the front end of the shaft 311 for preventing parts from slipping off, and a plurality of insert holes 322 bored thereon. The circuit board 33 connected with the connecting plate 32 has a through hole 330 in the center, a plurality of insert holes 331 bored thereon and respectively corresponding with the plurality of studs 13 of the main body 1, and at least one LED 332 installed thereon. The circuit board 33 is connected with the coil 320 of the connecting plate 32 by an electric wire (not shown in the drawings).

The base 4 connected with the luminous unit 3 has a central hole 41 for receiving the micro-generator 31 of the luminous unit 3 and a plurality of engage blocks 42 protruded at its underside. The central hole 41 has its circumferential edge provided with a plurality of holding members 410. Each of the engage blocks 42 has its inner wall provided with an engage groove 420 for engaging a spring ring 5 therein and its outer side provided with a projecting member 421 opposite to the engage groove 420.

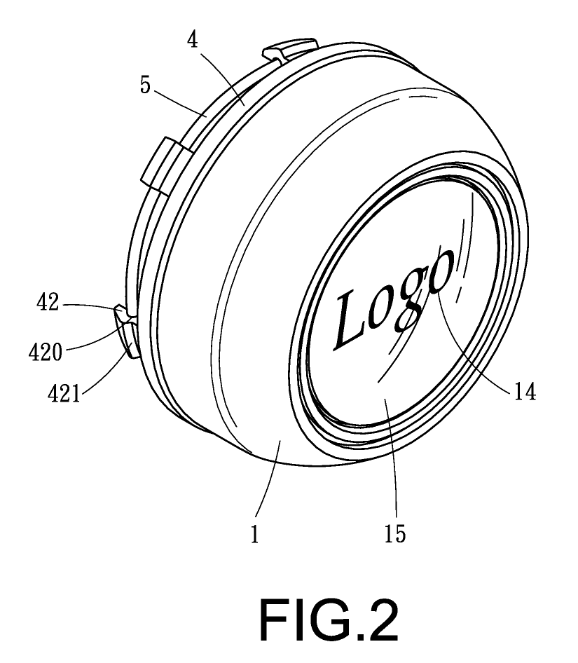

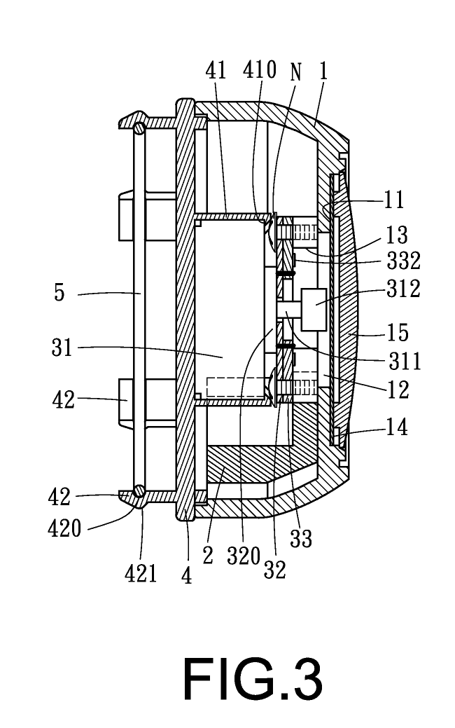

In assembling, referring to FIGS. 1, 2 and 3, firstly, insert the shaft 311 of the micro-generator 31 through the coil 320 of the connecting plate 32, the through holes 321 of the connecting plate 32 and the through holes 330 of the circuit board 33 with the coil 320 of the connecting plate 32 received in the inner side of the magnet 310 of the micro-generator 31, and then fit the fixing member 312 firmly on the front end of the shaft 311 of the micro-generator 31 to prevent parts from slipping off. Secondly, align the insert holes 322 of the connecting plate 32, the insert holes 331 of the circuit board 33 and the two insert holes 21 of the counter weight block 2 respectively to one another and corresponding with the plurality of studs 13 of the main body 1 for the bolts (N) to be respectively screwed therethrough and secured with the plurality of studs 13 for combining them together, letting the counter weight block 2 positioned at one side in the main body 1. Thirdly, place the micro-generator 31 in the central hole 41 of the base 4 with the holding members 410 of the central hole 41 firmly clasping the micro-generator 31, and then engage the spring ring 5 in the engage recesses 420 of engage blocks 42. Lastly, position the decorative plate 14 on the recessed surface 11 of the main body 1, and then cover the transparent cover 15 on the recessed surface 11 to be secured with the main body 1 by gluing or ultrasonic bonding, thus finishing assembly of the hubcap.

To assemble the hubcap on an outer side of a wheel axle, only have the engage blocks 42 of the base 4 inserted in the wheel axle with the projecting members 421 of the engage blocks 42 engaged in a position groove of the wheel axle that will be propped by the elastic force of the spring ring 5, thus quickly and stably assembling the hubcap on the outer side of the wheel axle.

By so designing, the figures and patterns on the decorative plate 14 of the hubcap can be seen clearly through the transparent cover 15, and when the automobile is running, the base 4 will be rotated together with the wheel axle, but the main body 1 disposed with the counter weight block 2 will not be actuated to rotate. Thus, the rotating base 4 will actuate the micro-generator 31 to rotate at a high speed and automatically generate electric current by friction with the stationary coil 320 to supply the circuit board 33 with electricity to start the at least one LED 332 to emit bright light for illuminating the decorative plate 14 in front and synchronously the bright light will be transmitted out through the transparent cover 15 for attracting attention and warning.

As can be understood from the above description, this invention has the following advantages.

1. The hubcap can be quickly and stably assembled on an outer side of a wheel axle by the engage blocks 42 of the base 4 in cooperation with support of elastic force of the spring ring 5.

2. The unique feature of this invention is the decorative plate 14 preset thereon with figures, patterns or logos.

3. The counter weight block 2 is disposed at one side in the main body 1; therefore, when the wheel axle is rotated, the main body 1 will not be actuated to rotate and the decorative plate 14 will be kept stationary, enabling the patterns or marks on the decorative plate 14 to be seen clearly to produce an original visual impression.

4. The transparent cover 15 is covered on the decorative plate 14 and secured with the main body 1 by gluing or ultrasonic bonding, able to effectively prevent the colored patterns on the decorative plate 14 from fading or exfoliating.

5. The luminous unit 3 can function to automatically emit light, which will be transmitted out through the transparent cover 15 to serve as eye-catching decoration and warning light.

While the preferred embodiment of the invention has been described above, it will be recognized and understood that various modifications may be made therein and the appended claims are intended to cover all such modifications that may fall within the spirit and scope of the invention.

1-3. (canceled)

4. A hubcap fixing structure comprising: a main body (1), a counter weight block (2), a luminous unit (3) and a base (4) as main components combined together; wherein
the main body (1) is an interior hollow body and is provided with a recessed surface (11) at a front side thereof; the recessed surface (11) has a holding stepped edge (110) disposed in a circumference thereof; a through hole (12) is formed in a center thereof and a plurality of studs (13) are fixed at a rear side thereof; a decorative plate (14) is positioned on the recessed surface (11) to be preset with patterns or logos; a transparent cover (15) is covered on the recessed surface (11);
the counter weight block (2) is threadably assembled in the main body (1) and is formed with two insert holes (21) to be correspondingly secured with the plurality of studs (13) of the main body (1) by means of bolts (N);
the luminous unit (3) positioned in the main body (1) is composed of a micro-generator (31), a connecting plate (32) and a circuit board (33); the micro-generator (31) has a round magnet (310) at an inner side thereof and a shaft (311) extending outward from a center thereof; the connecting plate (32) is positioned in front of the micro-generator (31) and has a coil (320) disposed at a rear side thereof to be received in an interior of the micro-generator (31) with an outer edge of the coil (320) closely resting against an inner diameter of the magnet (310), a through hole (321) is formed in a center for the shaft (311) of the micro-generator (31); a fixing member (312) is fitted at a front end of the micro-generator (31) for receiving and retaining the shaft (311) as the shaft (311) passing through the through hole (321) of the connecting plate (32); so as to prevent parts from slipping off, and a plurality of insert holes (322) are formed in the connecting plate (32);
a circuit board (33) connected with the connecting plate (32) has a through hole (330) in the center thereof; a plurality of insert holes (331) are formed in the circuit board (33) and are respectively corresponding with the plurality of studs (13) of the main body (1), and at least one LED (332) is installed on the circuit board (33); the circuit board (33) is connected with the coil (320) of the connecting plate (32) by an electric wire;
the base (4) is connected with the luminous unit (3) and is formed with a central hole (41) for receiving the micro-generator (31) of the luminous unit (3) and a plurality of engage blocks (42) are protruded from a rear edge of the base (4); the central hole (41) has its circumferential edge provided with a plurality of holding members (410);
wherein in assemby, the shaft (311) of the micro-generator (31) through the coil (320) of the connecting plate (32), the through holes (321) of the connecting plate (32) and the through holes (330) of the circuit board (33) with the coil (320) of the connecting plate (32) received in an inner side of the magnet (310) of the micro-generator (31), and then the fixing member (312) is firmly installed on a front end of the shaft (311) of the micro-generator (31) to prevent parts from slipping off; then the insert holes (322) of the connecting plate (32), the insert holes (331) of the circuit board (33) and the two insert holes (21) of the counter weight block (2) are aligned respectively to one another and the plurality of studs (13) of the main body (1) for the bolts (N) are to be respectively screwed therethrough and secured with the plurality of studs (13) for combining them together, the counter weight block (2) are positioned at one side in the main body (1); then the micro-generator (31) are installed in the central hole (4) of the base (4) with the holding members (410) of the central hole (41) firmly clasping the micro-generator (31), and then the spring ring (5) is engaged into the engage blocks (42); lastly, the decorative plate (14) are positioned on the recessed surface (11) of the main body (1), and then the transparent cover (15) covers on the recessed surface (11) to be secured with the main body (1) by gluing or ultrasonic bonding, thus finishing assembly of the hubcap.

5. The hubcap fixing structure as claimed in claim (4), wherein each of the engage blocks (42) has an inner wall provided with an engage groove (420) for engaging a spring ring (5) therein and an outer side provided with a projecting member (421) opposite to the engage groove (420).
